(19) United States
(12) Patent Application Publication
(10) Pub. No.: US 2009/0228814 A1
(43) Pub. Date: Sep. 10, 2009

(54) SYSTEMS AND METHODS FOR PROVIDING A MULTIFUNCTIONAL BOTTOM TOOLBAR FOR A USER INTERFACE

(75) Inventor: Hajime Kobayashi, Portland, OR (US)

Correspondence Address: AUSTIN RAPP & HARDMAN, 170 South Main Street, Suite 735, SALT LAKE CITY, UT, 84101, US

(73) Assignee: LUNARR, Inc., Portland, OR (US)

(21) Appl. No.: 12/044,629

(22) Filed: Mar. 7, 2008

(51) Int. Cl. G06F 3/048

(52) U.S. Cl. 715/764

(57) ABSTRACT

A web site system is described that comprises a computing device. The computing device comprises a web application for providing a user interface to be displayed by a web browser on a client computing device. The web application includes a bottom toolbar. The bottom toolbar maintains a bottom position on the web browser when the bottom toolbar is displayed on the client computing device. Bottom toolbar code causes the bottom toolbar to be displayed. The bottom toolbar code comprises a plurality of configurations. Each of the plurality of configurations causes a different bottom toolbar user interface to be displayed. The web application causes the bottom toolbar to change configurations.

### TECHNICAL FIELD

The present invention relates generally to computers and computer-related technology. More specifically, the present invention relates to systems and methods for providing a multifunctional bottom toolbar for a user interface.

### BACKGROUND

Computer technology has entered many areas to simplify manual tasks and to make information more readily available. Most people use several computer programs every day that greatly simplify their work day. In addition, through the use of a computer, vast amounts of information are readily available. Computer software and electronic information sources are typically found on storage media or storage devices such as hard drives, CD-ROMs, DVD-ROMs, etc., on a local computer, on a local computer network or a global computer network, such as the Internet.

Computer programs can be used for many purposes including assisting a person in performing his or her job. For example, word processors help computer users prepare documents, spreadsheet programs help users perform accounting functions and numerical analysis, diagnostic programs assist users in diagnosing problems, etc. There are many programs available to help users with almost any need they may have.

Networking technology enables a group of computer systems to share resources (e.g., files, computer programs, printers, and scanners). Computer networks are becoming increasingly important to productivity and are found in almost all walks of life. Many people access some kind of computer network almost every day. The Internet and the World Wide Web (the “web”) are a great source of information and facilitate communication between computer users and computer systems.

The use of the Internet and the web is widespread. Many computer users are familiar with web browsers and the many different kinds of web sites, information and services that are available from the Internet. Web site providers and services providers typically have a desire for users to have a good experience on their web site or in using their service. Providing a good user experience provides better customer service. The user interface that an end user interacts with is an important part of the user's experience. Thus, benefits may be realized from improved systems and methods for providing user interfaces.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is an embodiment of a user interface using a multifunctional toolbar located at the bottom on the user interface;

FIG. 2 is another embodiment of a user interface using a multifunctional toolbar located at the bottom on the user interface;

FIG. 3 is a further embodiment of a user interface using a multifunctional toolbar located at the bottom on the user interface;

FIG. 4 is another embodiment of a user interface using a multifunctional toolbar located at the bottom on the user interface;

FIG. 5 is a block diagram illustrating one embodiment of a web site that provides a web application with a bottom toolbar to a client device;

FIG. 6 is a flow diagram illustrating one embodiment of a method of providing a multifunctional bottom toolbar as part of a web site or as part of a web application;

FIG. 7 is an embodiment of a user interface using a multifunctional toolbar located at the bottom on the user interface;

FIG. 8 illustrates a user interface showing the multifunctional toolbar in document viewing mode;

FIG. 9 illustrates a user interface showing the multifunctional toolbar in document editing mode;

FIG. 10 illustrates the user interface of FIG. 9 showing the multifunctional toolbar in document editing mode after scrolling downwards;

FIG. 11 is an embodiment of a user interface that may be used during collaborative review of a document;

FIG. 12 is a block diagram illustrating one embodiment of multiple interfaces that may be accessed by a user;

FIG. 13 is an embodiment of a home interface;

FIG. 14 is an embodiment of a front side interface;

FIG. 15 is an embodiment of a back side interface; and

FIG. 16 is a block diagram illustrating the major hardware components typically utilized in a computing device.

### DETAILED DESCRIPTION

A web site system is described that includes a computing device and a web application for providing a user interface to be displayed by a web browser on a client computing device. The web application includes a bottom toolbar. The bottom toolbar maintains a bottom position on the web browser when the bottom toolbar is displayed on the client computing device. Bottom toolbar code causes the bottom toolbar to be displayed. The bottom toolbar code includes a plurality of configurations. Each of the plurality of configurations causes a different bottom toolbar user interface to be displayed. The web application causes the bottom toolbar to change configurations.

The system may also include a web server that sends the web application to users on the World Wide Web.

In one configuration, the bottom toolbar maintains a bottom position on the web browser when the bottom toolbar is displayed on the client computing device such that the bottom toolbar is outside scrollable area by an up/down scroll bar of the web browser. A further aspect of the system may include the bottom toolbar maintaining a bottom position on the web browser when the bottom toolbar is displayed on the client computing device such that the bottom toolbar is below a left/right scroll bar of the web browser.

The web application may include a plurality of modes of operation. In one configuration, the web application changing from a first mode of operation to a second mode of operation causes the bottom toolbar to display a different configuration. The plurality of modes of operation may include a document viewing mode and a document editing mode.

In a further configuration, the bottom toolbar code may only be used by the web browser when the web browser is providing the web application on the client computing device.

The system may further include an interface server for providing a client user interface to be displayed on the client computing device. The client user interface may provide a front user interface configured to display one of a plurality of electronic documents. A front user interface includes a front switching input. Activation of the front switching input causes the client user interface to switch from the front user interface to a back user interface. The client user interface may provide the back user interface configured to display one or more of a plurality of messages. The back user interface includes a back switching input. Activation of the back switching input causes the client user interface to switch from the back user interface to the front user interface.

A computer-implemented method for providing a multifunctional bottom toolbar on a user interface is also disclosed. A web site accessible by a computer network is provided. A web application associated with the web site is provided. The web application provides a user interface to be displayed by a web browser on a client computing device. A bottom toolbar is provided as part of the web application. The bottom toolbar maintains a bottom position on the web browser when the bottom toolbar is displayed on the client computing device. Bottom toolbar code causes the bottom toolbar to be displayed. The bottom toolbar code includes a plurality of configurations. Each of the plurality of configurations causes a different bottom toolbar user interface to be displayed. The web application causes the bottom toolbar to change configurations.

A computer-readable medium is also disclosed. A web site accessible by a computer network is provided. A web application associated with the web site is provided. The web application provides a user interface to be displayed by a web browser on a client computing device. A bottom toolbar is provided as part of the web application. The bottom toolbar maintains a bottom position on the web browser when the bottom toolbar is displayed on the client computing device. Bottom toolbar code causes the bottom toolbar to be displayed. The bottom toolbar code includes a plurality of configurations. Each of the plurality of configurations causes a different bottom toolbar user interface to be displayed. The web application causes the bottom toolbar to change configurations.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

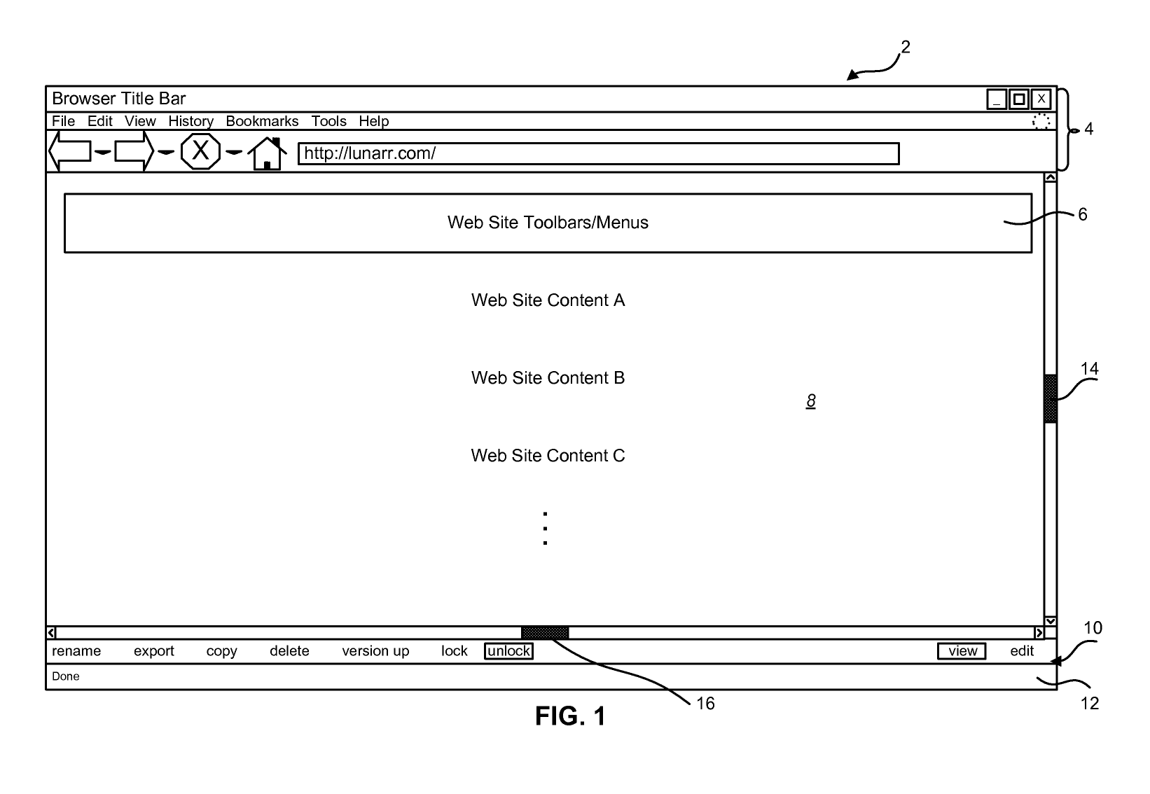

FIG. 1 is an embodiment of a user interface 2 using a multifunctional toolbar 10 located at the bottom on the user interface 2 (at the bottom of the user interface 2 window). The user interface 2 may be a web browser that includes a browser title/toolbar area 4. The browser title/toolbar area 4 may include the browser title bar, browser menus, browser toolbars, a web address location, etc. Generally, the browser title/toolbar area 4 is an area that the web browser itself may use for title bars, menus, toolbars, etc. The browser title/toolbar area 4 is typically not under the control of a web site that is being viewed by the browser.

Typically web sites include a web site toolbar/menu area 6 for allowing someone browsing the web site to navigate the web site or otherwise use the web site. This web site toolbar/menu area 6 is illustrated in FIG. 1. Web site content 8 is also shown and illustrated as “Web Site Content A”, “Web Site Content B”, “Web Site Content C”, etc. The web site content 8 may be anything that may be displayed or played by a web browser. Depending on the size of the user interface 2 window and the amount of web site content 8, up/down left/right scroll bars 16, 14 may also be provided by the web browser. The web browser may also display a bottom bar 12.

The multifunctional bottom toolbar 10 is provided at the bottom of the window. The bottom toolbar 10 is multifunctional in that the content of the toolbar 10 will change based on the web site content 8 or based on a mode of a web application. Examples and more details of the multifunctional aspects of the bottom toolbar 10 will be provided below. In some embodiments, the bottom toolbar 10 is provided as part of a web application, which may be considered a type of web site content 8. The bottom toolbar 10 is shown outside of scrollable area of the web site content 8. That is, the up/down scroll bar 14 does not scroll the bottom toolbar 10. Additionally, the up/down scroll bar 14 ends before the bottom toolbar 10 and does not overlap the bottom toolbar 10. Similarly, the left/right scroll bar 16 does not scroll the bottom toolbar 10. The left/right scroll bar 16 is positioned above the bottom toolbar 10. The up/down and left/right scroll bars 14, 16 may not be present, depending on the web site content 8 and the size of the user interface window 2.

The some embodiments the bottom toolbar 10 is multifunctional and is used as part of a web application. Some benefits from the bottom toolbar 10 are that it maximizes the usage of the area when user read/edit the document, and that it reduces the complexity of the user interface hierarchy. To a user, the bottom toolbar 10 will be regarded as the portion of the browser intuitively and cognitively. Many web sites and web applications currently in use provide toolbars in the web site toolbar/menu area 6 which is located at the top of the user interface 2 window. Such configurations increase the complexity of the navigation hierarchy and reduce the effective space of the window. In some instances, the amount of total space at the top of the user interface 2 window that ends up being used for menus and toolbars can be substantial and be frustrating the a user. Users typically would like more space available in the upper portion of the user interface 2 window for web site content 8.

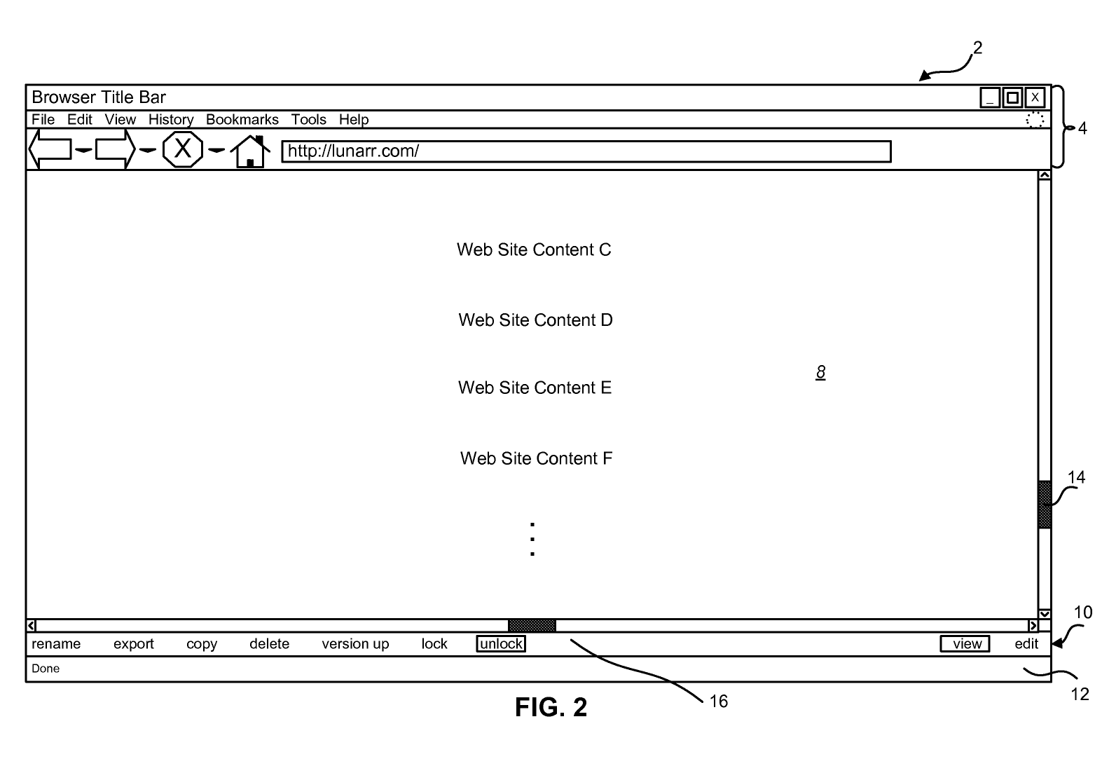

FIG. 2 is another embodiment of a user interface 2 using a multifunctional toolbar 10 located at the bottom on the user interface 2. FIG. 2 illustrates the user interface 2 window of FIG. 1 after a user has scrolled the up/down scroll bar 14 downwards. After scrolling downwards, the web site content 8 being shown in the browser does not include the web site toolbars/menus area 6 because the user has scrolled the content down past this area 6 to show “Web Site Content C” through “Web Site Content F”. The bottom toolbar 10 stays at the bottom of the user interface 2 window even though it is part of the web site content 8 or is part of a web application. Because the bottom toolbar 10 stays at the bottom, it helps the user perceive the bottom toolbar 10 as a portion of the browser.

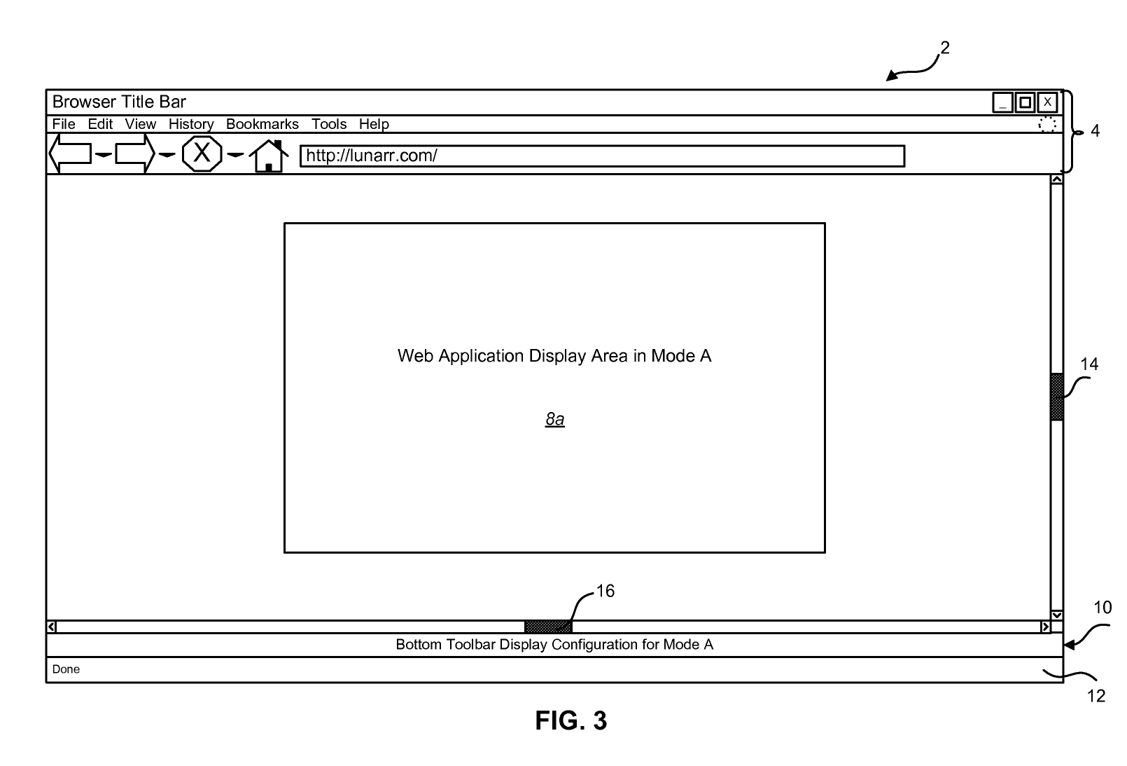

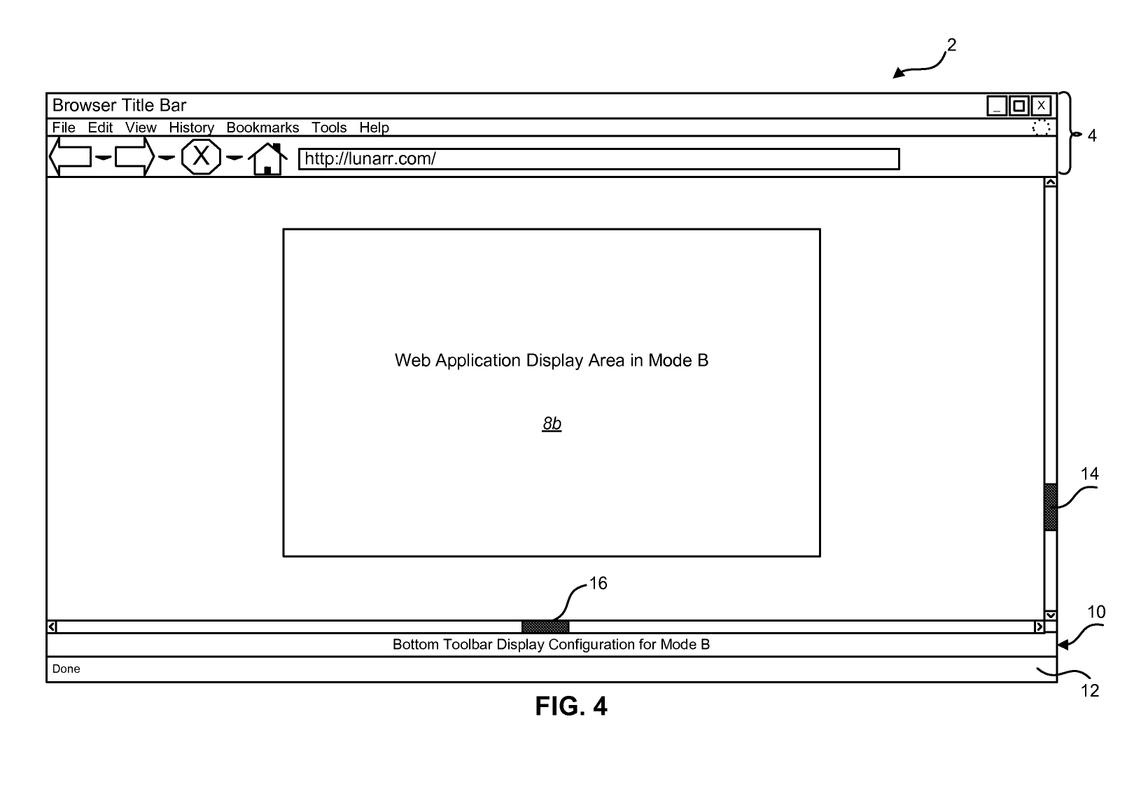

FIG. 3 is another embodiment of a user interface 2 using a multifunctional toolbar 10 located at the bottom on the user interface 2. FIG. 3 illustrates the user interface 2 window when a web application is running. A web application display area 8a for the web application running in mode A is shown. FIGS. 3 and 4 will illustrate an aspect of the multifunctional feature of the bottom toolbar 10. The bottom toolbar 10 is displaying a configuration for mode A to provide a tailored toolbar for the web application running in mode A. The bottom toolbar 10 includes two or more configurations that it 10 is capable of displaying. Assume that the user causes the web application to change modes from mode A to mode B. FIG. 4 illustrates the web application running in mode B. The display area 8b now shows the web application display area when the web application is running in mode B. The bottom toolbar 10 changes to display a configuration for mode B. As shown, the bottom toolbar 10 has the ability to change its content or configuration.

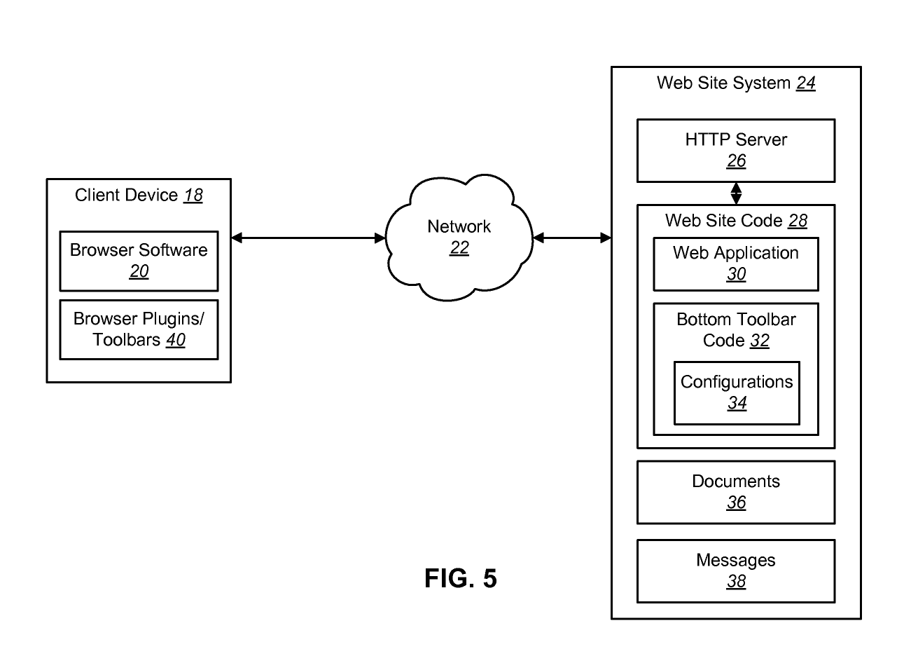

FIG. 5 is a block diagram illustrating one embodiment of a web site that provides a web application 30 with a bottom toolbar 10 to a client device 18. A web site system 24 comprises one or more computing devices that host or provide a web site. The web site system 24 includes a Hypertext Transfer Protocol (HTTP) server 26. The HTTP server 26 may be used to provide web pages or other web content from the web site code 28 to the client device 18 through a network 22. The HTTP server 26 may also provide documents 36 and messages 38 over the World Wide Web. The HTTP server 920 may publish and retrieve documents and messages in the Hypertext Markup Language (HTML).

The network 22 may be any kind of communications network that is capable of transferring web traffic. Examples of kinds of networks 22 that may be used include, but are not limited to, the Internet, a local area network, a wide area network, a telecommunications or cellular network, etc.

The web site system 24 includes web site code 28 that makes up one or more web sites. Web site code 28 may include many different kinds of data including HTML, Flash, scripts, PHP, Java Server Pages (JSP), Active Server Pages (ASP), ColdFusion (CFM), audio, video, etc. Regardless of the specific programming language used or the type of web site code 28, the web site code 28 may include a web application 30. A web application 30 is a program that is accessed by the client device 18 thereby enabling a user to use the web application 30 on the client device 18, where the part of the application 30 running on the client device 18 communicates with the web site system 24 (e.g., the HTTP server 26, web site code 28, or another piece of software). The web application 30 works with the World Wide Web. Some portions of the web application 30 run on the web site system 24 or some server on the Web. A user on a client device 18, using a web browser 20, interacts with a user interface portion of the web application 30 being displayed by the browser 20 on the client device 18. The part of the web application 30 running on the client device 18 may connect to and communicate with the web site system 24, including parts of the web application 30 still on the server, the HTTP server 26, or other back-end systems on the web site system 24. Some examples of web applications 30 include, but are not limited to, webmail, online retail sales, word processors, editors, spreadsheets, online auctions, image editors, sound editors, games, document viewers, email clients, messenger programs, etc.

The web site code 28 also includes bottom toolbar code 32. The bottom toolbar code 32 includes two or more configurations 34 for the bottom toolbar 10. Each configuration 34 provides a new or different toolbar appearance and/or toolbar functionality. The bottom toolbar code 32 is provided by the web site system 24 over the network 22 to the client device 18. The browser then displays the bottom toolbar 10 by executing or otherwise using the bottom toolbar code 32. The bottom toolbar 10 is part of the web application 30 and is not part of the web browser. The bottom toolbar 10 does not need to be installed to any web browser. For example, the bottom toolbar 10 does not need to be installed to the web browser like the Google Toolbar or the Yahoo! Toolbar do which require a user to download the toolbars and click on “install” button. The bottom toolbar 10 makes it possible to provide the same interface and features everywhere. The bottom toolbar 10 switches the content and features on the bottom toolbar 10 according to the content or state of the web application 30.

The client device 18 may be any kind of computing device capable of browsing the World Wide Web. The client 18 may include any computing device, including, but not limited to, a personal computer (PC), a laptop, a personal digital assistant (PDA), a cellular telephone, etc. The client device 18 includes browser software 20. The browser software 20 is used by the client device 18 to view web content from the World Wide Web. Additional browser plugins or toolbars 40 may also reside on the client device 18. Such browser plugins or toolbars 40 may be displayed in the browser title/toolbar area 4. The browser title/toolbar area 4 is typically not under the control of a web site that is being viewed by the browser.

As shown, the bottom toolbar code 32 is not part of the browser software 20. The bottom toolbar code 32 is part of the web application 30 that is provided to the client device 18 over the network 22. When the browser software 20 is running/viewing the web application 30, the bottom toolbar 10 may be displayed by the browser software 20 accessing or executing the bottom toolbar code 32. When the browser software 20 goes to another web site or another web application, the bottom toolbar 10 ceases to be displayed to the user. Thus, the bottom toolbar 10 is part of the web site code 28 or web application 30 and is not part of the browser software 20 or the browser plugins/toolbars 40 that remain displayed regardless of which web site or web application is running.

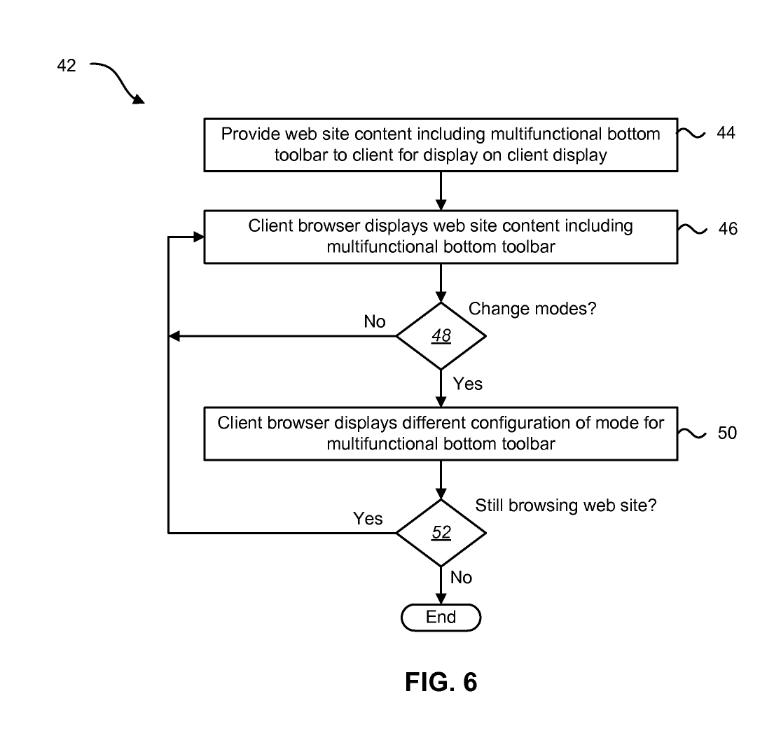

FIG. 6 is a flow diagram illustrating one embodiment of a method 42 of providing a multifunctional bottom toolbar 10 as part of a web site or as part of a web application. Web site content including a multifunctional bottom toolbar 10 is provided 44 to a client device 18 for display to a user. A client browser 20 displays 46 the web site content including the multifunctional bottom toolbar 10. It is determined 48 whether the bottom toolbar 10 should change modes.

If the bottom toolbar 10 does not need to change configuration modes, then the client browser continues to display 46 the web site content. If the bottom toolbar 10 does need to change configuration modes, then the client browser 20 displays 50 a different configuration or mode for the multifunctional bottom toolbar 10.

The web site content or web application may determine 10 whether the bottom toolbar 10 needs to changes configuration modes by monitoring and processing user input. For example, if the user clicks on an “edit” button, the bottom toolbar 10 may change to an edit configuration mode. If the user clicks on an “import” button, the bottom toolbar 10 may change to an import configuration mode. Furthermore, if the user clicks on a “view” button, the bottom toolbar 10 may change to a view configuration mode.

If the user is still browsing 52 the web site or still using the web application, then the client browser may continue displaying 46 the web site content or may continue running the web application. If the user discontinues using the web site or web application, the method may end.

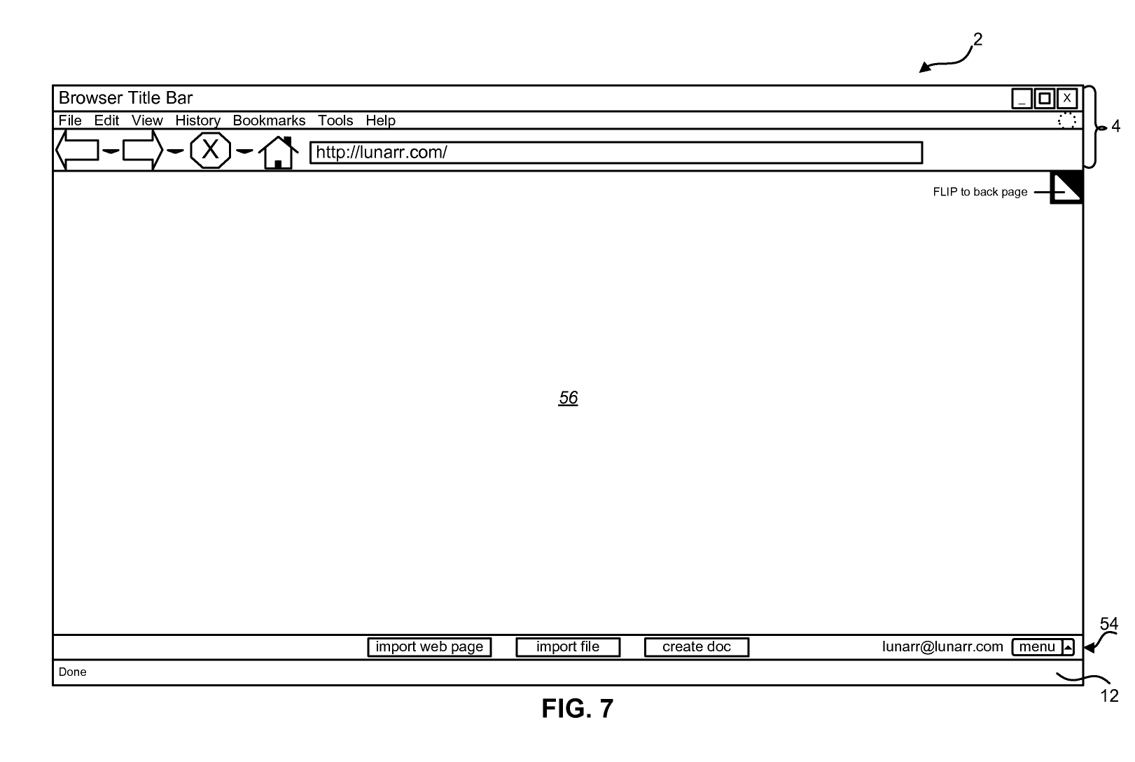

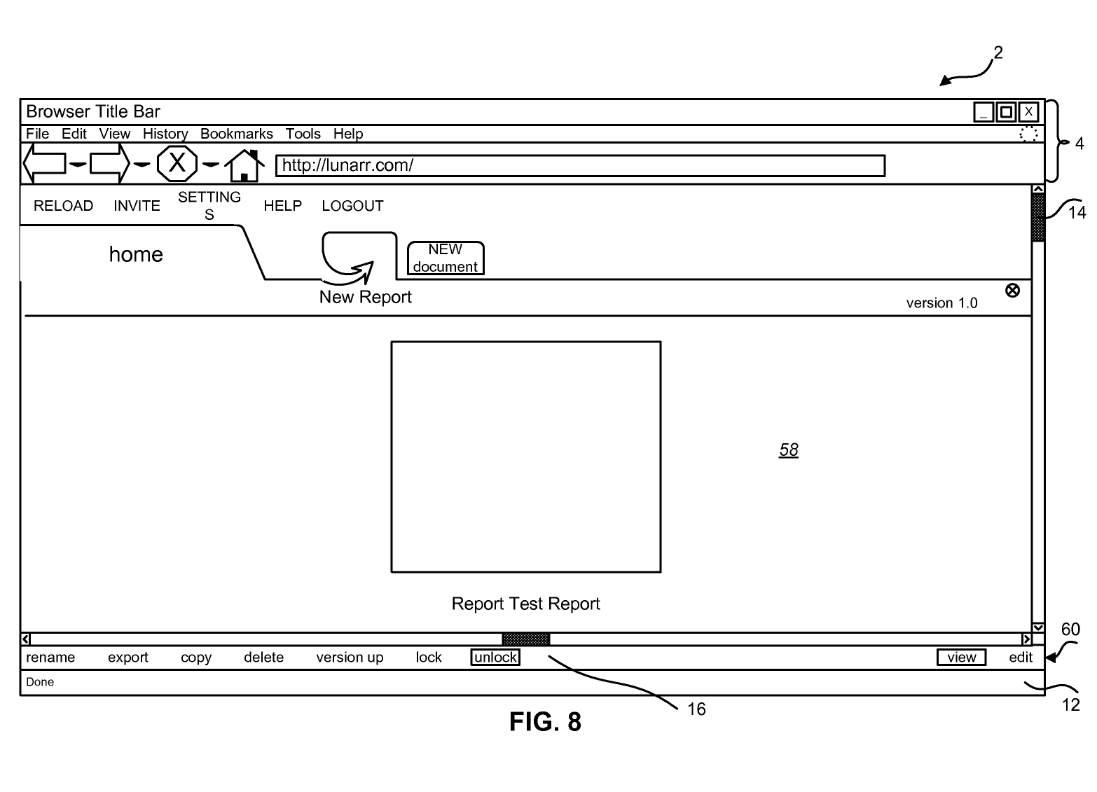

FIG. 7 is another embodiment of a user interface 2 using a multifunctional toolbar 10 located at the bottom on the user interface 2. FIG. 7 illustrates the user interface 2 window when certain web site content 56 is being displayed. In the example shown in FIG. 7, the web site content 56 is in a mode for importing or creating a file. The bottom toolbar 54 is displaying a configuration for this mode for importing or creating a file, as shown by the buttons “import web page”, “import file”, and “create doc”. As discussed above, the bottom toolbar 54 is capable of displaying various configurations or user interfaces depending on the mode of the web site content 56 or web application. FIG. 8 illustrates how the bottom toolbar 54 of FIG. 7 may change to the bottom toolbar 60 of FIG. 8 when the mode changes from that of importing or creating a file to viewing a file or document.

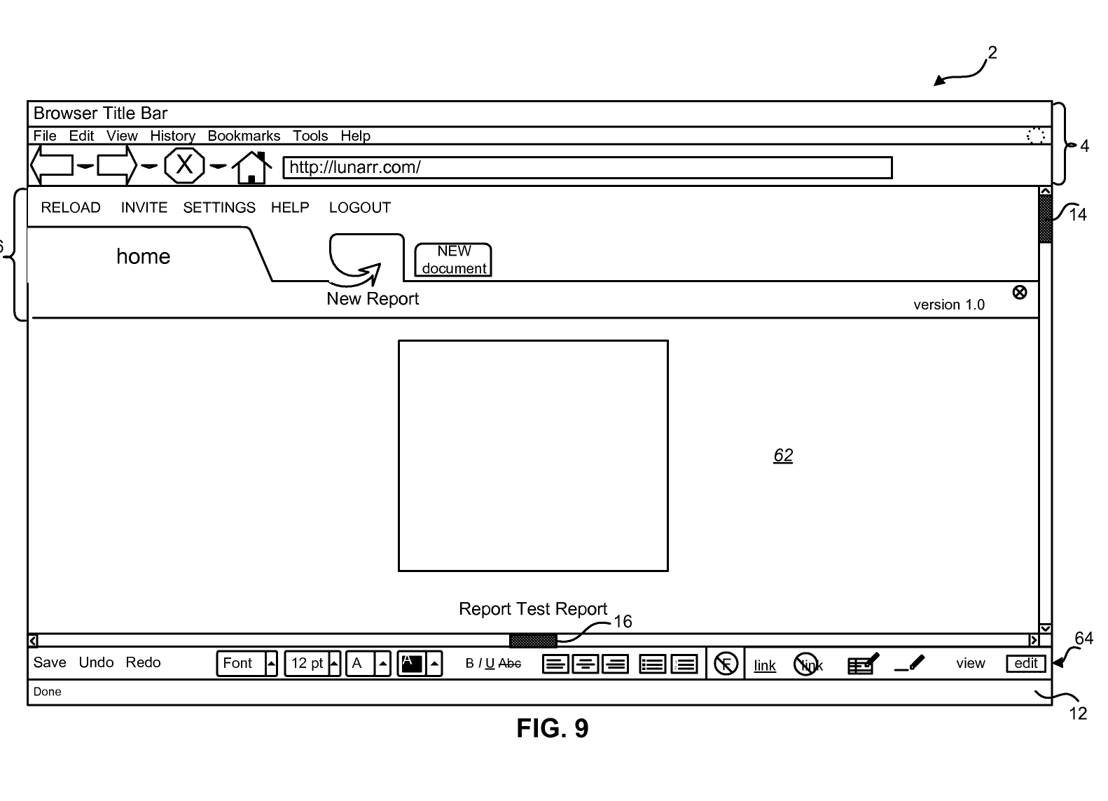

FIG. 8 illustrates a user interface 2 showing the multifunctional toolbar 60 in a document viewing mode. The user may cause a document viewing web application 58 to run and show a document. The web application 58 may have a plurality of capabilities besides simply showing a document. In the example shown in FIG. 8, the web application 58 is in a mode for viewing a document or file. The bottom toolbar 60 is displaying a configuration for this mode for viewing a document, as shown by the various buttons on the bottom toolbar 60 (“rename”, “export”, “copy”, and so forth). While displaying the document viewing configuration, the bottom toolbar 60 hides the configuration for importing or creating a file as illustrated in FIG. 7. FIGS. 7 and 8 illustrate that the bottom toolbar is capable of displaying various configurations or user interfaces depending on the mode of the web site content 56 or web application 58. Further to this aspect of the bottom toolbar 10, FIG. 9 illustrates how the bottom toolbar 54 of FIG. 7 and/or the bottom toolbar 60 of FIG. 8 may change to the bottom toolbar 64 of FIG. 9 when the mode changes to an editing mode. The bottom toolbar code 32 is causing the different configurations 54, 60 of the toolbar 10 to be visible.

FIG. 9 illustrates a user interface 2 showing the multifunctional toolbar 64 in document editing mode. The user may cause a document editing web application 62 to run and show a document for editing. In one embodiment, one web application 62 may have multiple modes including a mode for viewing and a mode for editing. In the example shown in FIG. 9, the web application 62 is in a mode for editing a document or file. The bottom toolbar 64 is displaying a configuration for this mode for editing a document, as shown by the various buttons on the bottom toolbar 64. While displaying the document editing configuration, the bottom toolbar 64 hides the configuration for importing or creating a file as illustrated in FIG. 7 and hides the configuration for viewing a document as illustrated in FIG. 8. FIGS. 7, 8 and 9 illustrate that the bottom toolbar is capable of displaying various configurations or user interfaces depending on the mode of the web site content 56 or web application 58, 62.

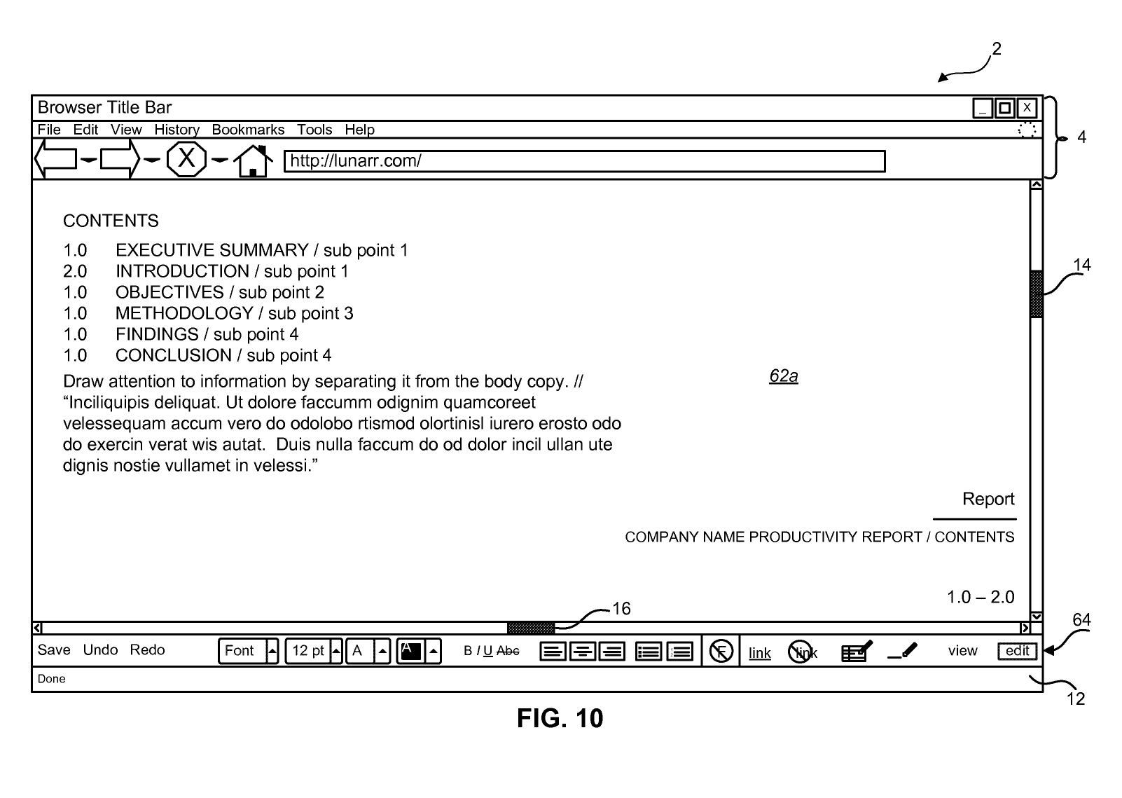

FIG. 9 also illustrates a web site toolbars/menu area 6. The user interface 2 of FIG. 9 is transitioned to the user interface 2 of FIG. 10 by a user scrolling the up/down scroll bar 14 downward. As shown in FIG. 10, the web site toolbars/menu area 6 is no longer visible. However, the bottom toolbar 64 is still visible in FIG. 10 even though the user scrolled downward to view additional content from the web application 62a. The bottom toolbar 64 stays at the bottom of the browser window to give the user the perception that the bottom toolbar 64 is part of the browser.

The bottom toolbar 10 may be used in many different kinds of web content and web applications. One possible use of the bottom toolbar 10 may be with a system for providing document collaboration using a front and back framework. It is to be understood that this possible use is only an example and is not meant to limit the different ways in which the bottom toolbar 10 may be used. One possible system for providing document collaboration using a front and back framework will be described below.

Collaborative review of an electronic document generally suffers from several problems. Some examples of these problems may include redundant reviewing, feedback tracking, error logging, missing context, feedback conflicts and approval collection.

Redundant reviewing may occur when a document is reviewed by multiple reviewers and each reviewer inspects the same section of the document. Each of the reviewers may discover the same errors or issues within the document without knowledge of the other reviewers. Redundant reviewing can involve a substantial waste of time affecting the multiple reviewers and the owner(s) of the document.

A reviewer may also have difficulty in tracking the feedback provided by other reviewers regarding a document. For example, a reviewer may not be aware when feedback is incorporated into subsequent versions of the document. In addition, feedback conflicts may occur between different reviewers because one reviewer may not have access to the most current version of the document. The owner(s) of the document may also face the difficulty of maintaining an organized history of which reviewer provided certain feedback.

Furthermore, approval collection may be difficult with a plurality of reviewers. For example, it is often difficult for the document owner(s) to secure meaningful approvals from each of their reviewers. Reviewers may be negligent in returning an approval or disapproval, or even give an approval without having performed an adequate review. As previously mentioned, with a plurality of reviewers, it can be difficult to centrally track approvals and review comments. A reviewer may be more inclined to perform a quality review and give a more honest approval if their comments and sign-off approval are easily viewable by the other reviewers and the document owner(s).

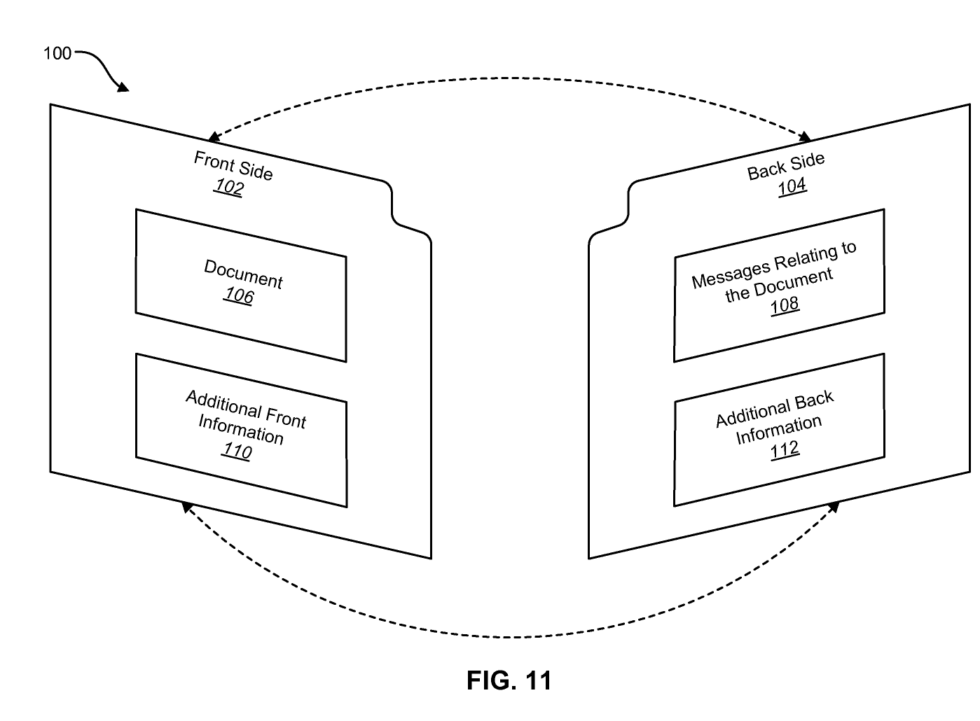

FIG. 11 is one embodiment of a user interface 100 that may be used during collaborative review of a document 106. The interface 100 may include a front side 102 and a back side 104. A user may alternate between the front side 102 and the back side 104. In the embodiment of FIG. 11, a user may either view the front side 102 or the back side 104. Through some user input, the interface 100 would flip from the front side 102 to the back side 104, and visa versa. It is to be understood that flipping between the front side 102 and the back side 104 indicates a conceptual flip and not a physical flip. For illustrative purposes, FIG. 11 shows both the front side 102 and the back side 104. In operation, the embodiment would typically only display either the front side 102 or the back side 104. The front side 102 and the back side 104 may each include information that may be displayed to the user. The information displayed on the front side 102 may be different than the information displayed on the back side 104. In one embodiment, the information associated with the front side 102 may be linked (or connected) to the information associated with the back side 104.

The front side 102 may include the document 106. In one embodiment, the document 106 includes an electronic document. The document may be a Hyper-Text Markup Language (HTML) document that is created by an editing tool included in the front side 102. The document 106 may also be a webpage, graphic, picture, music, etc. In one embodiment, the webpage may include a web application. For example, web applications that include documents, spread sheets, etc. may be shown in the front side 102 as the document 106. In addition, the document 106 may be a link for downloading a file that is to be reviewed. The link may be for any type of document, such as, but not limited to, Microsoft Word, Microsoft Excel, Microsoft Power Point, etc. based document, Photoshop based document, illustrator file, etc. In one embodiment, a document that is Microsoft based or any other type of document may be converted into an HTML format so that a user may view and edit the document in the front side 102. The document 106 may be any type of digital or electronic information that is displayed on the front side 102. In one embodiment, a user may upload and convert a document to the hyper text markup language (HTML) format. A wordprocessor/editing function may be implemented to edit the document in the HTML format.

A user may access the user interface 100 and view the front side 102. The document 106 may be displayed to the user. The user may view or edit the document 106. For example, if the document 106 included a document that had been converted from a Microsoft Word based document with text to a HTML based document, the user may delete or add text to the document 106. If the document 106 included a picture, the user may edit the colors of the picture, change the size of the picture, etc. The front side 102 may also include additional front information 110 that may be displayed to the user. The additional front information 110 may include tools to assist the user in editing the document 106. The additional front information 110 may also include various commands the user may select to be executed on the document 106. For example, the various commands may include a command to save, print, copy, export, version up, view only setting, etc. the document 106. Further, the additional front information 110 may include an identifier that identifies the document 106 to the user.

The back side 104 may include messages 108 relating to the document 106. The messages 108 may be related to edits executed on the document 106 displayed on the front side 102. A user may receive a message 108 from another user that has edited or viewed the document 106. The messages 108 may be organized in an electronic mailbox associated with a user. The mailbox may include messages that are organized according to the particular user and document the message is related to. The back side 104 may also include additional back information 112. The additional back information 112 may include various commands that may be executed on the messages 108. Examples of the various commands may include a command to reply to a message, forward a message, delete a message, etc. The additional back information 112 may also include an indication when new messages 108 are received, information relating to each user that accesses the document 106, information about a revision log and versions of the document 106 as well as information about other documents and links that relate to the document 106. In one embodiment, the back side 104 includes meta information such as collaborators, linked documents, revision log, additions to the messages, etc.

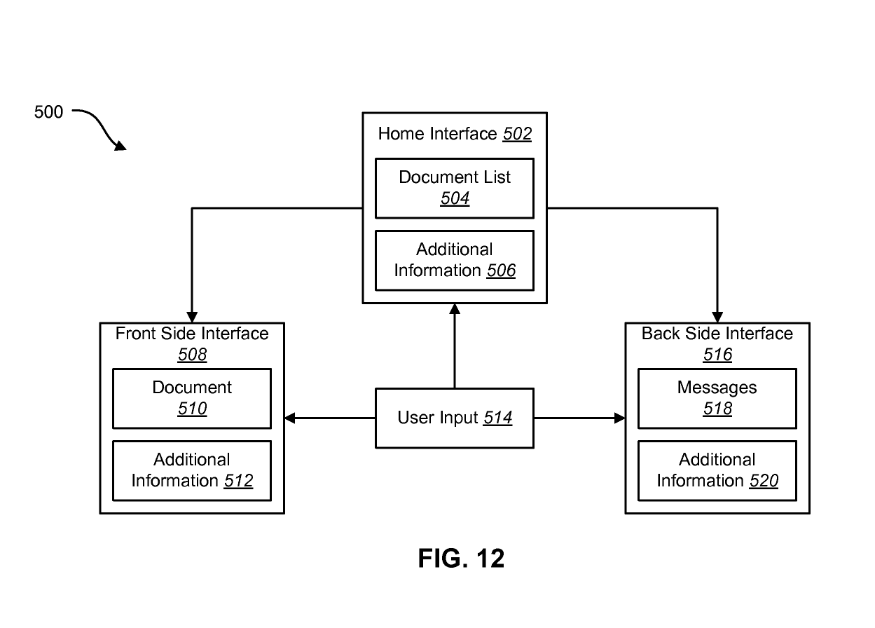

FIG. 12 is a block diagram illustrating one embodiment 500 of multiple interfaces that may be accessed by a user. A home interface 502 may include a document list 504 and additional home information 506. The document list 504 may include a list of documents the user may access to read, edit, send and receive messages, etc. A front side interface 508 may include a document 510 and additional front information 512. The document may be the document selected from the document list 504 from the home interface 502. A back side interface 516 may include messages 518 and additional back information 520. The messages may be messages relating to the document 510 displayed by the front side interface 508. User input 514 may allow a user to access each of these multiple interfaces. The user input may include a mouse click, keyboard command, etc.

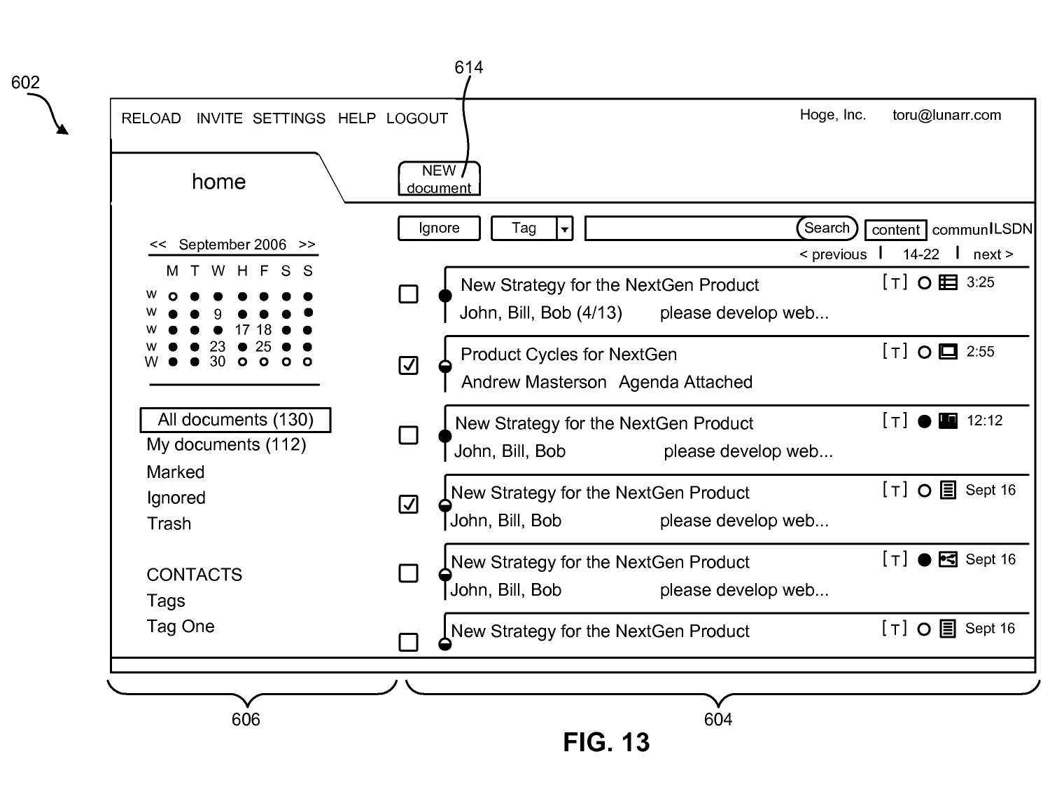

FIG. 13 is an embodiment of the home interface 602. As illustrated, the home interface 602 may include the document list 604 which lists one or more documents a user may access. Each of the documents in the document list 604 is the most current version of the document. The document list 604 may also include a summary of messages that have been received regarding a particular document on the list 604. As previously explained, the messages may be selected from the home interface 602 and viewed via the back side interface 104.

The home interface 602 also includes additional home information 606. In one embodiment, the additional home information 606 includes options for the user such as reload, invite, settings, help, logout, etc.

In a further embodiment, the additional home information 606 includes a list of contacts for the user. The information 606 may also indicate which documents from the document list 604 have been previously viewed by the user, which documents are new since the user last viewed the document list 604, etc. The home interface 602 may also allow the user to search the document list 604 for a particular document. The user may also assign or create a tag (also referred to as a label) associated with a document from the list 604. The tag (or label) may further define the properties of a document. The additional home information 606 may also include a calendar that provides an indication of an event. The event may be a deadline for certain edits for a document to be completed. An event may be indicated by the date appearing as a number on the calendar. If no such event exists on a certain day, a dot may be used to indicate the absence of an event.

The home interface 602 also includes an area 614 for user input. In one embodiment, the user input may include a tab 614 that the user may click with the computer mouse in order to execute a certain command. The command may be to create a new document. In addition, the user may click the name of a document within the document list 604 in order to view, edit, etc. the selected document.

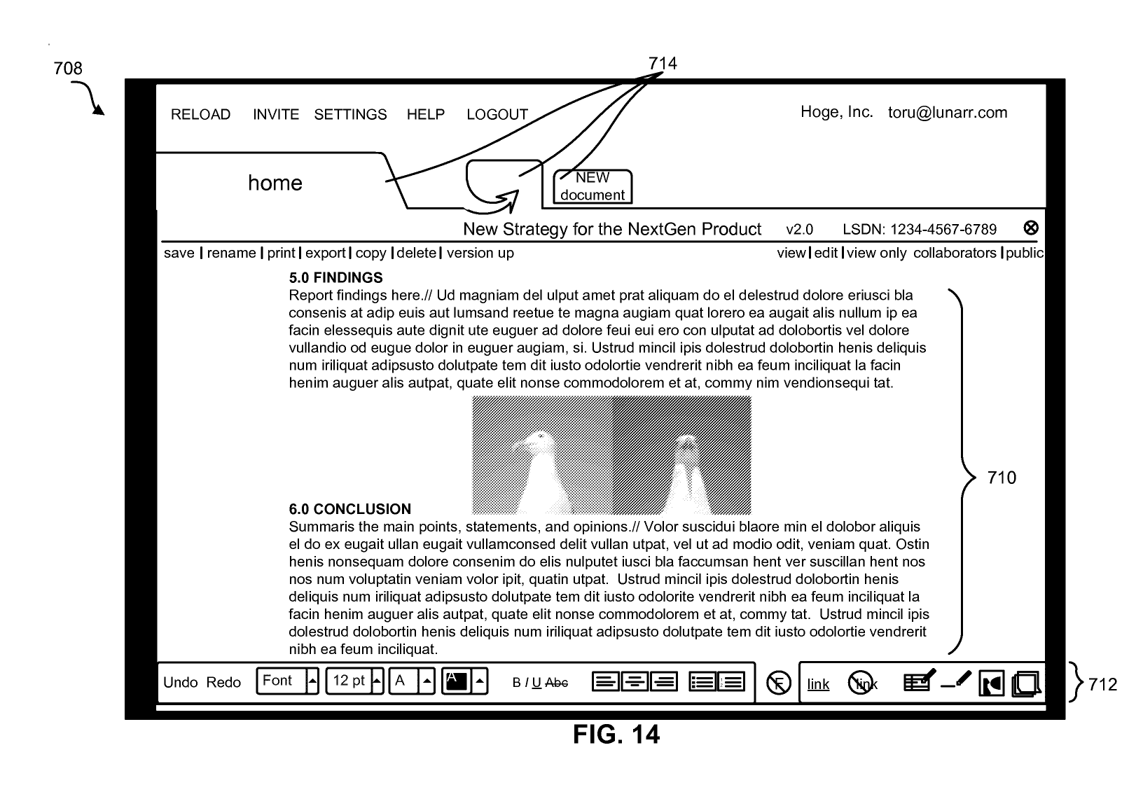

FIG. 14 is one embodiment of the front side interface 708. The interface 708 includes the document 710. The document 710 may be read, edited, etc. by a user. A bottom toolbar 712 may provide editing functions that assist the user to edit the document 710. For example, in an embodiment where the document 710 is a word-processing type of document, the bottom toolbar 712 may include commands to edit the font style, size, etc. of the text of the document 710. In addition, the user may underline, strikethrough, italicize, etc. the text. The bottom toolbar 712 may vary depending on what kind of document 710 is being displayed. The bottom toolbar 712 also includes commands to save, rename, print, export, copy, delete, etc. the document 710. In addition, the front side interface 708 includes a user input 714. The user input 714 may be one or more tabs. A user may click on one tab to switch to the back side interface. Another tab may allow a user to access the home interface 602. Further, another tab may allow a user to create a new document.

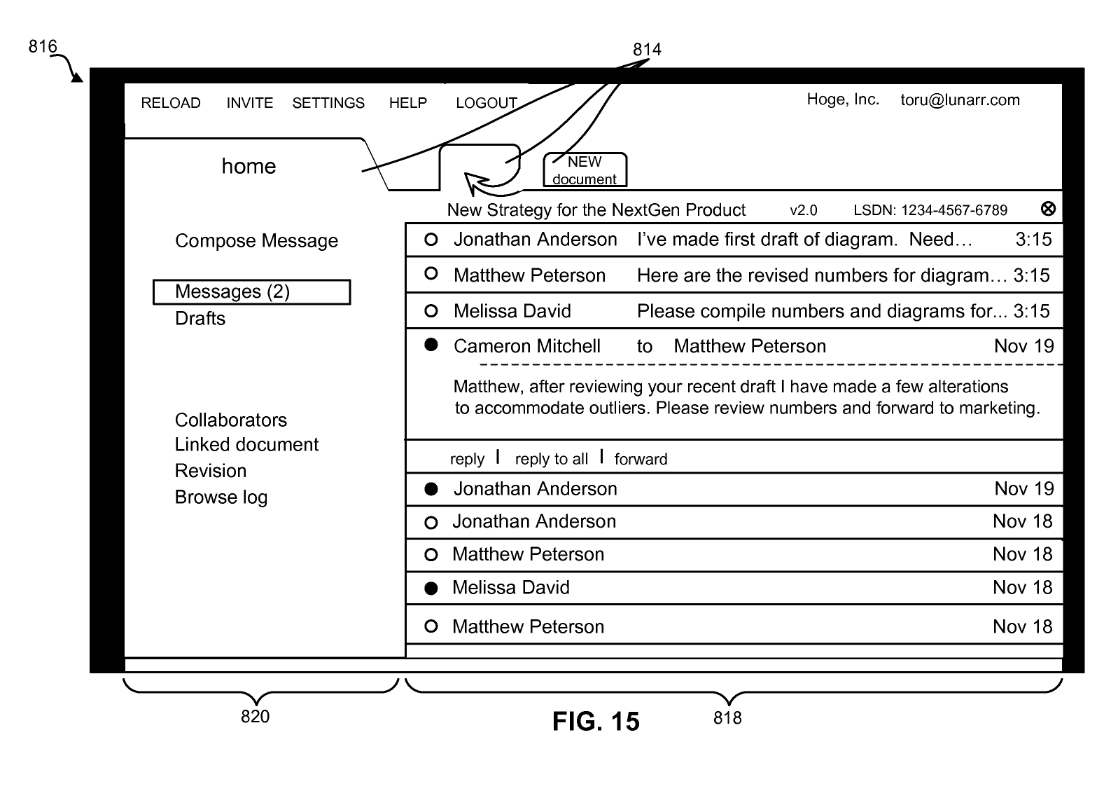

FIG. 15 is one embodiment of the back side interface 816. The interface includes one or more messages 818 associated with the document 710 displayed on the front side interface 708. The messages 818 may be received and viewed by the user to whom the messages are directed. A user may also create and send one or more messages to other users via the back side interface 816 and may attach document(s) when sensing the message (document may be the document created on the system 200, uploaded file, URL, etc.) The interface 816 includes additional back information 820. The information 820 may indicate the number of new messages that have been received since the user last viewed the messages 818. The additional back information 820 may also include a list of the collaborators for the document 710. In other words, the list of collaborators provides an identification of the additional users that have access to view, edit, etc. the document 710. The information 820 may also provide the identity of the document 710 associated with the messages 818. The additional back information 820 may also include a log of all the revisions executed on the document 710 and the user which incorporated such revisions and version information. The additional back information 820 may also include information and links of other documents that are related to the document 710.

The back side interface 816 also includes a user input 814. The user input 814 may be one or more tabs. A user may click on one tab to switch to the front side interface. Another tab may allow a user to access the home interface 602. Further, another tab may allow a user to create a new document.

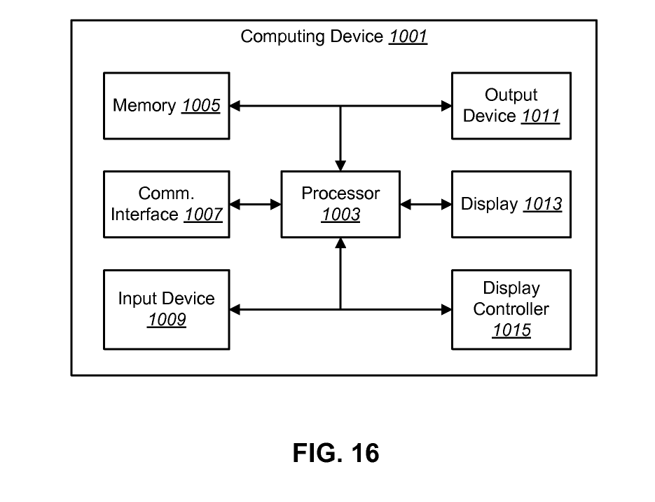

FIG. 16 illustrates various components that may be utilized in a computing device 1001. Embodiments of a client device 18 and a web site system 24 are implemented through one or more computing devices 1001. The illustrated components may be located within the same physical structure or in separate housings or structures.

The device 1001 includes a processor 1003 and memory 1005. The processor 1003 controls the operation of the computing device 1001 and may be embodied as a microprocessor, a microcontroller, a digital signal processor (DSP) or other device. The processor 1003 typically performs logical and arithmetic operations based on program instructions stored within the memory 1005.

The device 1001 typically also includes one or more communication interfaces 1007 for communicating with other electronic devices. The communication interfaces 1007 may be based on wired communication technology, wireless communication technology, or both. Examples of different types of communication interfaces 1007 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 1001 typically also includes one or more input devices 1009 and one or more output devices 1011. Examples of different kinds of input devices 1009 include a keyboard, mouse, microphone, remote control device, button, joystick, trackball, touchpad, lightpen, etc. Examples of different kinds of output devices 1011 include a speaker, printer, etc. One specific type of output device which is typically included in a computer system is a display device 1013. Display devices 1013 used with embodiments disclosed herein may utilize any suitable image projection technology, such as a cathode ray tube (CRT), liquid crystal display (LCD), light-emitting diode (LED), gas plasma, electroluminescence, or the like. A display controller 1015 may also be provided, for converting data stored in the memory 1005 into text, graphics, and/or moving images (as appropriate) shown on the display device 1013.

Of course, FIG. 16 illustrates only one possible configuration of a computing device 1001. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A web site system comprising:
a computing device, the computing device comprising:
a web application for providing a user interface to be displayed by a web browser on a client computing device, wherein the web application includes:
a bottom toolbar, wherein the bottom toolbar maintains a bottom position on the web browser when the bottom toolbar is displayed on the client computing device, wherein bottom toolbar code causes the bottom toolbar to be displayed, and wherein the bottom toolbar code comprises:
a plurality of configurations, wherein each of the plurality of configurations causes a different bottom toolbar user interface to be displayed, and wherein the web application causes the bottom toolbar to change configurations.

2. The system of claim 1, further comprising a web server that sends the web application to users on the World Wide Web.

3. The system of claim 1, wherein the bottom toolbar maintains a bottom position on the web browser when the bottom toolbar is displayed on the client computing device such that the bottom toolbar is outside scrollable area by an up/down scroll bar of the web browser.

4. The system of claim 1, wherein the bottom toolbar maintains a bottom position on the web browser when the bottom toolbar is displayed on the client computing device such that the bottom toolbar is below a left/right scroll bar of the web browser.

5. The system of claim 1, wherein the web application comprises a plurality of modes of operation.

6. The system of claim 5, wherein the web application changing from a first mode of operation to a second mode of operation causes the bottom toolbar to display a different configuration.

7. The system of claim 1, wherein the bottom toolbar code is only used by the web browser when the web browser is providing the web application on the client computing device.

8. The system of claim 5, wherein the plurality of modes of operation include a document viewing mode and a document editing mode.

9. The system of claim 1, wherein the system further comprises an interface server for providing a client user interface to be displayed on the client computing device, wherein the client user interface provides:
a front user interface configured to display one of a plurality of electronic documents, wherein a front user interface includes a front switching input, wherein activation of the front switching input causes the client user interface to switch from the front user interface to a back user interface; and
the back user interface configured to display one or more of a plurality of messages, wherein the back user interface includes a back switching input, wherein activation of the back switching input causes the client user interface to switch from the back user interface to the front user interface.

10. A computer-implemented method for providing a multifunctional bottom toolbar on a user interface, the method comprising:
providing a web site accessible by a computer network;
providing a web application associated with the web site, wherein the web application provides a user interface to be displayed by a web browser on a client computing device; and
providing a bottom toolbar as part of the web application, wherein the bottom toolbar maintains a bottom position on the web browser when the bottom toolbar is displayed on the client computing device, wherein bottom toolbar code causes the bottom toolbar to be displayed, and wherein the bottom toolbar code comprises:
a plurality of configurations, wherein each of the plurality of configurations causes a different bottom toolbar user interface to be displayed, and wherein the web application causes the bottom toolbar to change configurations.

11. The method of claim 10, wherein the bottom toolbar maintains a bottom position on the web browser when the bottom toolbar is displayed on the client computing device such that the bottom toolbar is outside scrollable area by an up/down scroll bar of the web browser.

12. The method of claim 10, wherein the bottom toolbar maintains a bottom position on the web browser when the bottom toolbar is displayed on the client computing device such that the bottom toolbar is below a left/right scroll bar of the web browser.

13. The method of claim 10, wherein the web application comprises a plurality of modes of operation.

14. The method of claim 13, wherein the web application changing from a first mode of operation to a second mode of operation causes the bottom toolbar to display a different configuration.

15. The method of claim 10, wherein the bottom toolbar code is only used by the web browser when the web browser is providing the web application on the client computing device.

16. The method of claim 13, wherein the plurality of modes of operation include a document viewing mode and a document editing mode.

17. The method of claim 10, further comprising providing a client user interface to be displayed on the client computing device, wherein the client user interface provides:
a front user interface configured to display one of a plurality of electronic documents, wherein a front user interface includes a front switching input, wherein activation of the front switching input causes the client user interface to switch from the front user interface to a back user interface; and
the back user interface configured to display one or more of a plurality of messages, wherein the back user interface includes a back switching input, wherein activation of the back switching input causes the client user interface to switch from the back user interface to the front user interface.

18. A computer-readable medium comprising executable instructions to:
provide a web site accessible by a computer network;
provide a web application associated with the web site, wherein the web application provides a user interface to be displayed by a web browser on a client computing device; and
provide a bottom toolbar as part of the web application, wherein the bottom toolbar maintains a bottom position on the web browser when the bottom toolbar is displayed on the client computing device, wherein bottom toolbar code causes the bottom toolbar to be displayed, and wherein the bottom toolbar code comprises:
a plurality of configurations, wherein each of the plurality of configurations causes a different bottom toolbar user interface to be displayed, and wherein the web application causes the bottom toolbar to change configurations.
